(19) United States
(12) Patent Application Publication
(10) Pub. No.: US 2019/0197897 A1
(43) Pub. Date: Jun. 27, 2019

(54) VIRTUALLY CONFIGURED PARKING AREA

(71) Applicant: Faraday&Future Inc., Gardena, CA (US)

(72) Inventors: Xiufeng Song, San Jose, CA (US); Carlos John Rosario, San Jose, CA (US)

(21) Appl. No.: 15/690,163

(22) Filed: Aug. 29, 2017

Related U.S. Application Data
(60) Provisional application No. 62/381,302, filed on Aug. 30, 2016.

(51) Int. Cl. G08G 1/14

(52) U.S. Cl. CPC G08G 1/143; G08G 1/146

(57) ABSTRACT

Methods, systems, and apparatuses to receive at least one request for parking a vehicle in a parking area; virtually partition a portion of the parking area based on at least one of (a) dimensions of the vehicle or (b) attributes of the parking area, in the response to the request; and dynamically assign the virtually partitioned portion of the parking area to the vehicle, in response to the at least one request for parking the vehicle.

### CROSS-REFERENCE TO RELATED APPLICATIONS

This application claims the benefit of U.S. Provisional Application No. 62/381,302, filed Aug. 30, 2016, the entirety of which is hereby incorporated by reference.

### BACKGROUND

Aspects of the disclosure relate to parking of vehicles in parking areas. Currently, parking areas are divided, such as via painted partitioning lines, into a fixed number of parking spaces of predetermined size. Therefore, the number and size of parking spaces in a parking area cannot be altered on demand to more efficiently accommodate a varying number of vehicles with varying sizes in the parking area. Exemplary embodiments of the disclosure address these problems, both individually and collectively.

### SUMMARY

Certain embodiments are described for virtually configuring parking spaces in a parking area. An exemplary embodiment includes an apparatus having at least one processor configured to receive at least one request for parking a vehicle in a parking area, to virtually partition a portion of the parking area based on at least one of (a) dimensions of the vehicle or (b) attributes of the parking area, in the response to the request, to dynamically assign the virtually partitioned portion of the parking area to the vehicle, in response to the at least one request for parking the vehicle; and a data storage unit configured to communicate with the processor and to store information on the virtually partitioned portions.

Another exemplary embodiment includes an apparatus having a means for receiving at least one request for parking a vehicle in a parking area; means for virtually partitioning a portion of the parking area based on at least one of (a) dimensions of the vehicle or (b) attributes of the parking area, in the response to the request; and means for dynamically assigning the virtually partitioned portion of the parking area to the vehicle, in response to the at least one request for parking the vehicle.

Another exemplary embodiment includes a method comprising receiving at least one request for parking a vehicle in a parking area; virtually partitioning a portion of the parking area based on at least one of (a) dimensions of the vehicle or (b) attributes of the parking area, in the response to the request; and dynamically assigning the virtually partitioned portion of the parking area to the vehicle, in response to the at least one request for parking the vehicle.

### BRIEF DESCRIPTION OF THE DRAWINGS

Aspects of the disclosure are illustrated by way of example. In the accompanying figures, like reference numbers indicate similar elements.

FIG. 1 illustrates an example environment in which various aspects of the disclosure can be implemented.

FIG. 2 includes a block diagram further illustrating various components for implementing aspects of the disclosure.

FIG. 3 illustrates exemplary operation flows of various aspects of the disclosure.

FIG. 4 in conjunction with FIGS. 1-3, further illustrates exemplary aspects of the disclosure.

FIGS. 5A-B illustrate an exemplary display for implementing various aspects of the disclosure.

FIG. 6 illustrates further exemplary operation flows of various aspects of the disclosure.

FIG. 7 in conjunction with FIG. 6, further illustrates exemplary aspects of the disclosure.

### DETAILED DESCRIPTION

Examples are described herein in the context of virtually configuring parking spaces in a parking area. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

The term “virtual partitioning” as used throughout the specification refers to a partitioning that is not based on or relies on fixed markers defining dimensions of a partitioned portion, such as via painted partitioning lines defining a parking space in a parking lot, but rather to a partitioning characterized by dimensions that can be altered on the fly based on the needs of the vehicle. The term “dynamically assigning” as used throughout the specification refers to an assignment that performed as the demand arises.

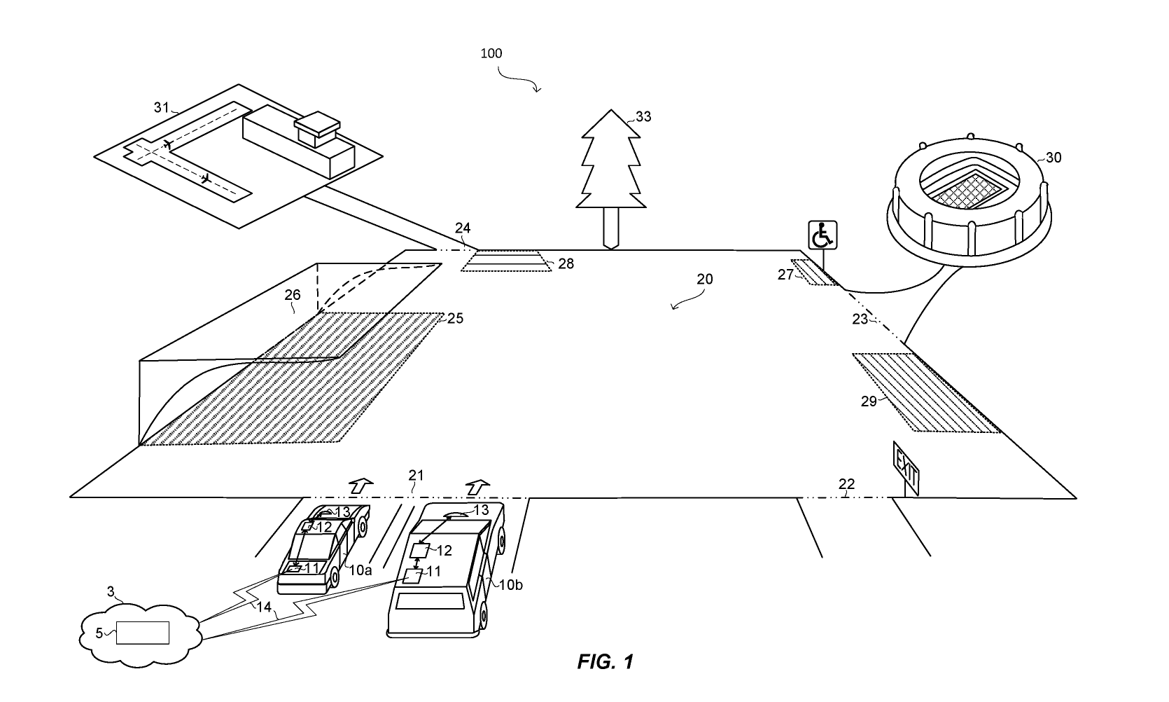

FIG. 1 illustrates an example environment 100 in which the various aspects of the disclosure can be implemented in the exemplary context of virtually configuring parking spaces in an exemplary parking area 20. As shown in FIG. 1, parking area 20 has a number of attributes, such as a rectangular shape that is sized to accommodate a number of vehicles, such as vehicles 10a and 10b, vehicular entrance 21 and exit 22, and pedestrian access points 23 and 24 leading to respective venues 30 and 31, such as a sports arena and an airport, respectively. As shown in FIG. 1, parking area 20 may have portions of different attributes, such as covered region(s) 25 under covering structure(s) 26 (e.g. car port), handicap designation region(s) 27, and region(s) such as 28 and 29 in relative proximity to at least one of venues 30 or 31. As shown, region(s) may have multiple attributes, such as region(s) 27 having both a handicap designation and in relative proximity to pedestrian access points 23 for venue 30.

As described in greater detail below, parking spaces in parking area 20 have virtually configured perimeters. As such, parking area 20 either does not have predetermined, fixed partitioning markings (e.g. via painted partitioning lines) to define its parking spaces, or such fixed partitioning markings are not used by the implementations described in this disclosure in determining parking space(s) for vehicle(s) in parking area 20.

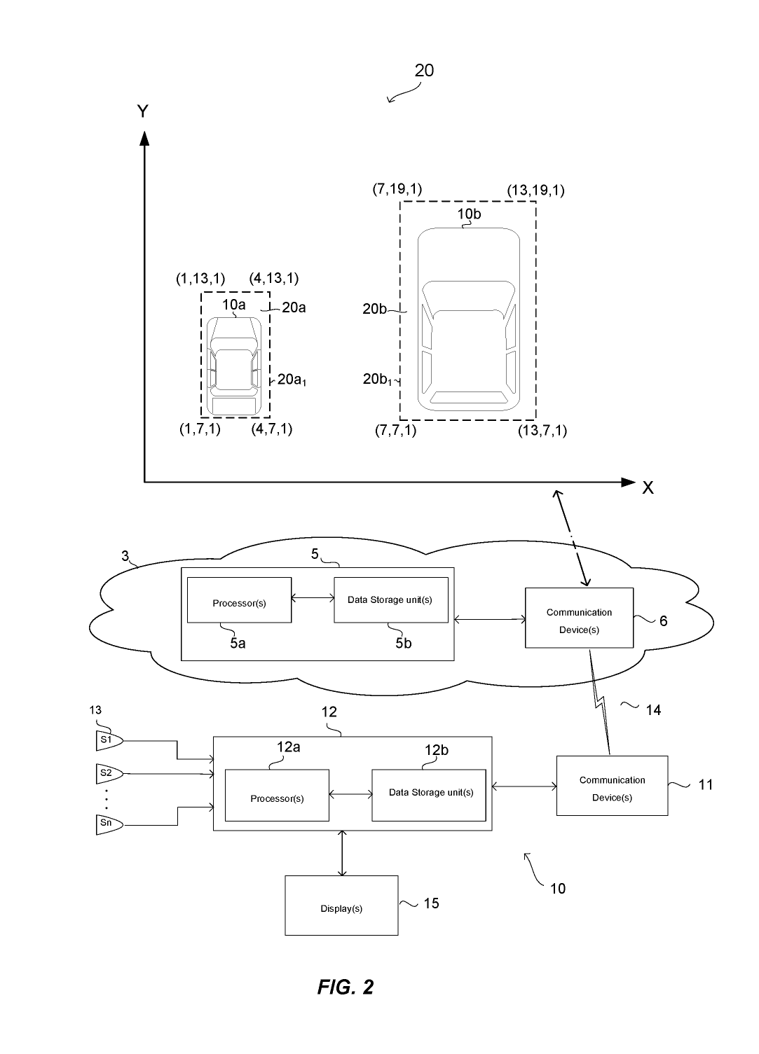

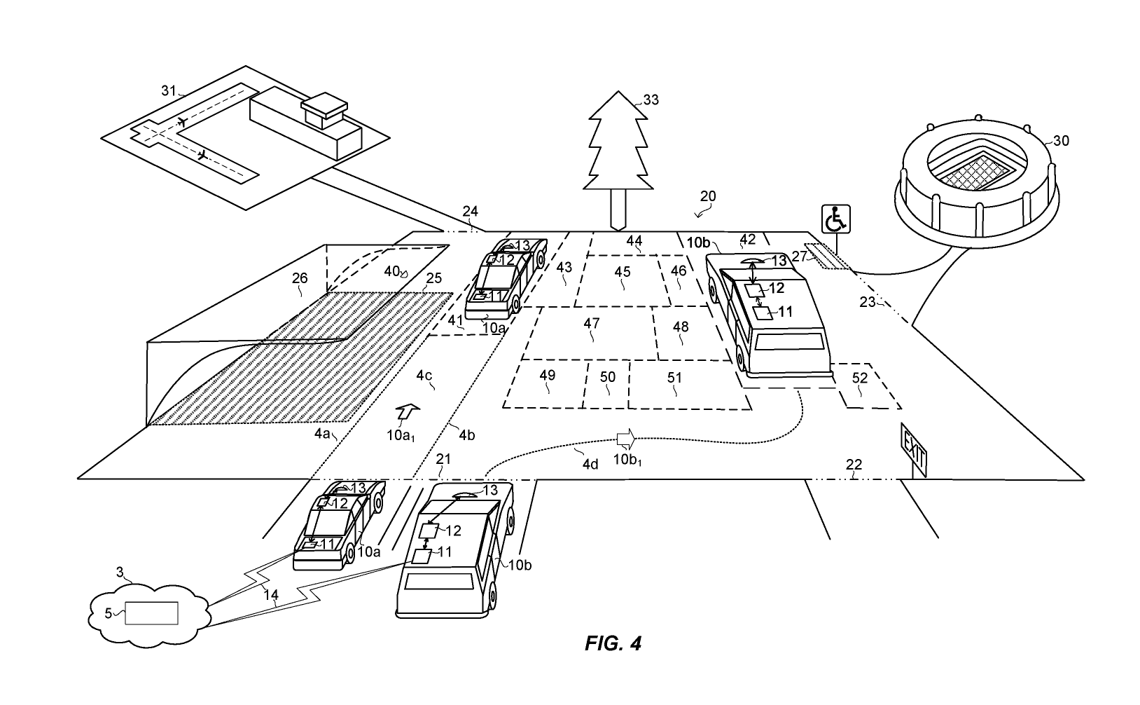

FIG. 2 includes block diagrams which, in conjunction with FIG. 1, further illustrate the operations and various components for implementing aspects of the disclosure. As shown in FIG. 2, exemplary vehicle(s) 10, such as vehicle 10a or 10b, include parking system(s) 12 which include processor(s) 12a and data storage unit(s) 12b. Parking system(s) 12, housed within vehicle(s) 10, may receive data, such as parking or navigation data from sensors(s) 13, as described below and in greater detail in conjunction with FIGS. 4-6. In an exemplary embodiment, display unit(s) 15, such as interactive display unit(s), are in communication with parking system(s) 12 and are configured to provide and/or receive visual and/or audio data to and from driver of vehicle 10 as described below and in greater detail in conjunction with FIGS. 4-6.

In an exemplary embodiment, vehicle(s) 10 are configured to communicate via communication device(s) 11, such as by wireless means 14, with communication device(s) 6 on a remote server 5, such as one residing in a data cloud 3. Remote server 5 includes processor(s) 5a and data storage unit(s) 5b. Processor(s) 5a is configured to receive request(s) for parking vehicle(s) 10, such as vehicles 10a or 10b, in parking area 20, and to virtually partition portion(s), such as portions 20a or 20b, of parking area 20 based on (a) dimensions of vehicles 10a or 10b and/or (b) attributes of parking area 20, in response to the received request. Data storage unit(s) 5b, coupled to processor(s) 5a, are configured to store information, such as attributes of parking area 20, and virtually partitioned portion(s) such as 20a or 20b. In an exemplary embodiment, the dimensions and other pertinent attribute(s) of the vehicle(s) are obtained from database(s), such as a look-up table(s), containing information, such as the make, model, year, etc., of the vehicle(s).

In remote server 5, processor(s) 5a define virtual perimeter(s) of partitioned portion(s), such as perimeters 20a₁ and 20b₁ (illustrated as dashed-lines), which define portions 20a and 20b respectively, as shown in FIG. 2.

As shown in FIG. 2, in one embodiment, each of virtual perimeters 20a₁ and 20b₁, or their respective portions 20a and 20b, may be represented in various ways. As one example, a rectangular perimeter may be defined by four corner points, each corresponding to a set of (x, y, z) coordinates in a Cartesian coordinate system. Thus, perimeter 20a1 may be represented by the four corners (x=1, y=7, z=1), (x=1, y=13, z=1), (x=4, y=13, z=1), and (x=4, y=7, z=1). Other perimeters, such as 20b i, may be similarly represented, as shown in FIG. 2. For simplicity, the Z-axis used for parking area's elevation, including different levels of a multi-level parking area, is not shown in the “bird's eye” view of FIG. 2.

In an exemplary embodiment, in response to received parking request(s) from vehicles 10a and 10b, processor(s) 5a dynamically assign virtually partitioned portion(s) of parking area 20, such as portions 20a and 20b, to vehicles 10a and 10b, as shown in FIG. 2. As described below in greater detail, processor(s) 5a virtually partitions portion(s), such as portions 20a or 20b, based on dimensions of vehicles 10, such as vehicles 10a or 10b. In the exemplary embodiment of FIG. 2, vehicle 10b has larger dimensions than vehicle 10a, and therefore processor(s) 5a may virtually partition a portion 20b that is correspondingly larger in area than virtually partitioned portion 20a for smaller vehicle 10a. Correspondingly, processor(s) 5a may determine a higher parking cost for portion 20b than portion 20a. In this way, some or all of parking area 20 can be virtually configured to parking spaces of different sizes, based on different dimensions of vehicle(s) 10.

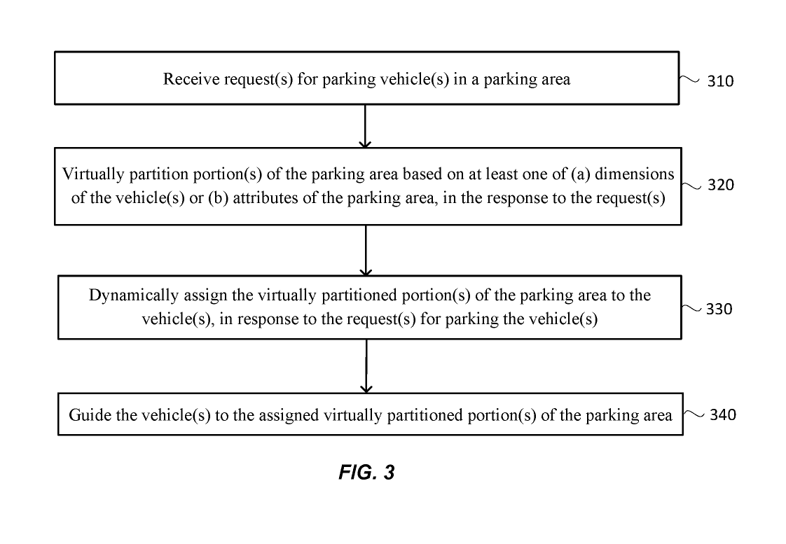

FIG. 3, in conjunction with FIG. 4, illustrates an exemplary operation flow of various aspects of the disclosure. Starting in block 310, processor(s) 5a in remote server 5 receive request(s) for parking vehicles 10a or 10b in parking area 20, which are at entrance 21 of parking area 20, as shown in FIG. 4. Request(s) can be received directly from vehicles 10a and 10b (as shown), indirectly via a parking station relay (not shown), or by other means.

Next, in block 320, processor(s) 5a virtually partitions portions 41 and 42 (discussed later in reference to FIG. 4) of parking area 20 based on dimensions of each vehicle 10a and 10b, as previously described in conjunction with FIG. 2. As shown in FIG. 4, virtually partitioned portions 41 and 42 are of different sizes based on the corresponding different dimensions of their respective vehicles 10a and 10b, and so as illustrated, virtually partition portion 41 is substantially smaller than virtually partition portion 42.

Processor(s) 5a may also determine a location within parking area 20 for virtually partitioned portions 41 and 42, based on attributes of parking area 20, such as covered region(s) 25 under covering structure(s) 26 (e.g. car port), or handicap designation region(s) 27. In the exemplary embodiment shown in FIG. 4, location of virtually partitioned portion 41 is selected to be in proximity of access point 24 for airport venue 31. The determination can be made based on available information such as an indication that a present or future occupant of vehicle 10a is travelling to or returning from airport venue 31. Likewise for vehicle 10b, location of virtually partitioned portion 42 is selected to be in proximity of access point 23 for sports arena venue 30. In another example, a nature of activity within sports arena venue 30, such as approximated duration time for a sporting event based on the sport being played (e.g. football games, track and field competitions, etc.) may influence the determination on how to virtually partition parking area 20 and locate portions for each parked vehicle.

Parking area 20 may further be virtually partitioned to more portion(s), such as portions 43 through 52, as shown. For simplicity of illustration, FIG. 4 shows portion(s) 43 through 52 as being adjacent to one another and rectangular in shape, although it is contemplated to be within the scope of the present disclosure that parking area 20 can be virtually partitioned into variety of shapes and sizes, such as oval, triangular, etc, as well as a variety of configurations for locations of the virtually partitioned portion(s) and access routes. In this way, parking area 20 can be virtually reconfigured as needed, such as based on a nature of activity within one or more of its serviced venues, such as venues 30 or 31. Therefore, the number, size and location of parking spaces in parking area 20 can be altered as the need arises to more efficiently accommodate a varying number of vehicles 10 with varying sizes in parking area 20.

Next, in block 330, processor(s) 5a dynamically assigns, (e.g. on the fly as the demand arises), virtually partitioned portion(s) 41 and 42 of parking area 20 to corresponding vehicle(s), such as vehicles 10a and 10b, respectively. The assignment is then communicated to parking system(s) 12 of each vehicle 10a and 10b.

Next in block 340, vehicles 10a and 10b are guided to their respective assigned virtually partitioned portions 41 and 42. In an exemplary embodiment, a virtual route is defined for each vehicle to its virtually partitioned portion. For example, as shown in FIG. 4, routes 4c (defined by dotted-lines 4a and 4b ) and 4d (illustrated as a single dotted-line) are respectively defined for vehicles 10a and 10b, which then proceed along directions shown by arrows 10a₁ and 10b₁, to their respective virtually partitioned portions 41 and 42.

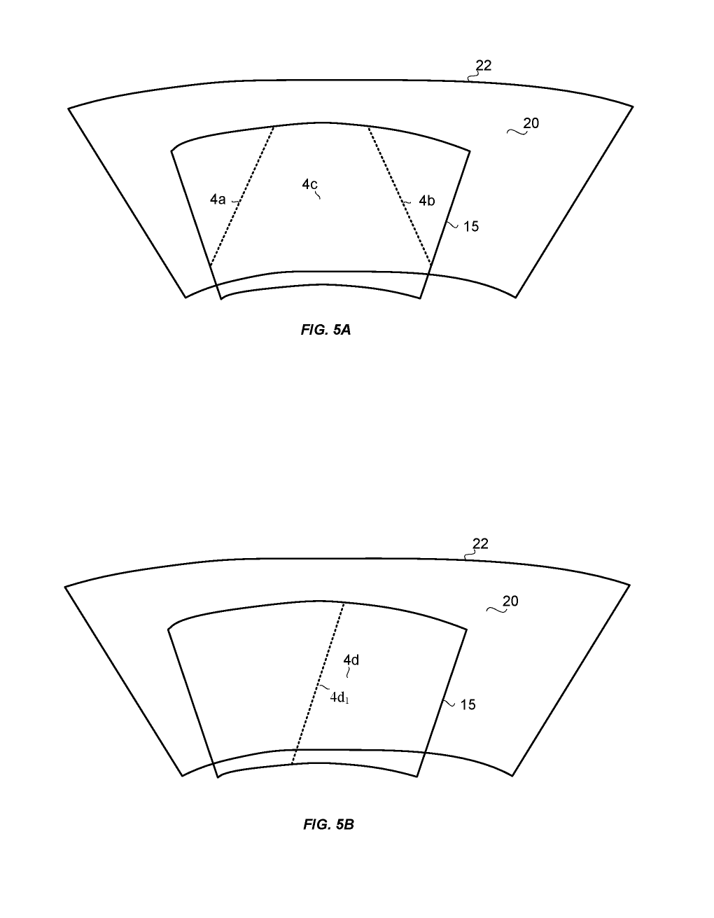

In an exemplary embodiment, each of processor(s) 12 housed within vehicles 10a and 10b is configured to obtain virtual representation information for their respective virtual routes 4c and 4d, such as from remote server 5, and to autonomously navigate vehicle 10a and 10b based on obtained virtual representation information. Alternatively or additionally, virtual routes 4c and 4d may be presented to a driver in vehicle 10a and/or 10b, to help the driver see the virtual route that has been established, so the vehicle can be autonomously, semi-autonomously, or manually driven to the virtually partitioned portions. As discussed below in further detail with respect to FIG. 5, such visual presentation may be performed using a heads-up display (HUD), i.e., display integrated into a windshield of a vehicle, a display mounted on a dash portion of the vehicle, etc. Virtually partitioned portions, such as 41 and 42, may also be presented to the driver in a similar fashion.

In an exemplary embodiment, sensors 13 on each of vehicle 10a and 10b are configured to monitor a movement of vehicles 10a and 10b toward their assigned virtually partitioned portions 41 and 42. Each of sensor(s) 13 is configured to perform one or more types of scene observation such as via a camera, thermal sensing such as infrared, Light Detection And Ranging (LIDAR) or Radio Detection and Ranging (RADAR), amongst other forms of sensing. It is also contemplated that sensor(s) 13 could be distributed throughout vehicle 10 in different configurations or arrangements that provide improved data gathering, operating either as stand-alone sensors or as a collection of sensors working together.

In another exemplary embodiment, sensor(s) 40 may also be placed at location(s) within sensing range of parking area 20 (such as atop a covering structure 26), so to monitor movement of vehicles 10a and 10b, and to report the information to remote server 5 for guidance accuracy purposes. Sensor(s) 40 may also provide remote server 5 with additional information, such as traffic dynamics within parking area 20, and availability of any unoccupied portion(s) in parking area 20.

In another exemplary embodiment, each of processor(s) 12 housed within vehicles 10a and 10b is configured to obtain virtual representation information for their respective virtual routes 4c and 4d, such as from remote server 5, and to display virtual markers to drivers of vehicle 10a and 10b, as described below in conjunction with FIGS. 5A-B.

FIGS. 5A-5B show an exemplary embodiment in which the virtual route information are graphically displayed on a visualization module display unit 15, such as a head-up display (HUD), configured to virtually superimpose virtual routes 4c and 4d on driver's view of parking area 20. Here, for example display unit 15 may be part of a vehicle, such as vehicle 10a travelling on route 4c, or vehicle 10b travelling on route 4d.

As shown in FIG. 5A, virtual representation lines 4a and 4b which together define route 4c are virtually superimposed by display unit 15 on parking area 20 to assist a driver of vehicle 10a in following virtually determined route 4c to its assigned virtually partitioned portion 41 of parking area 20, as shown in FIG. 4. In an alternate exemplary embodiment shown in FIG. 5B, a single virtual representation line 4d₁, is used to assist a drive of vehicle 10b in following virtually determined route 4d to its assigned virtually partitioned portion 42 of parking area 20, as shown in FIG. 4. In an exemplary embodiment, display unit 15 is placed such that it is aligned with a portion or all of a driver's view of the windshield 22. In another exemplary embodiment (not shown), display unit 15 is integrally formed with windshield 22, and occupies a portion or all of windshield 22.

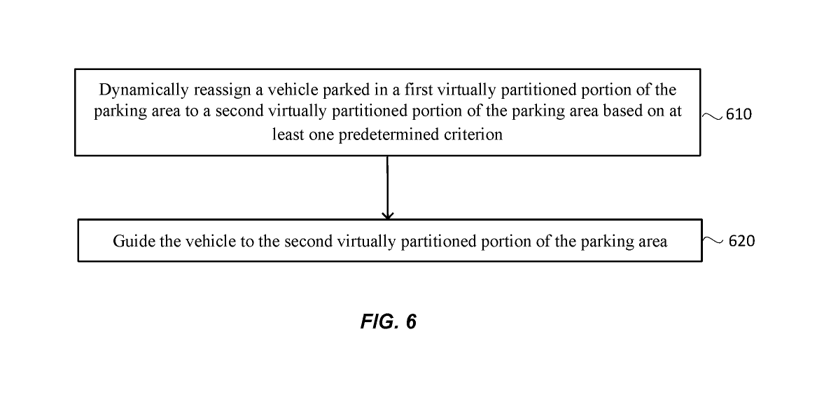

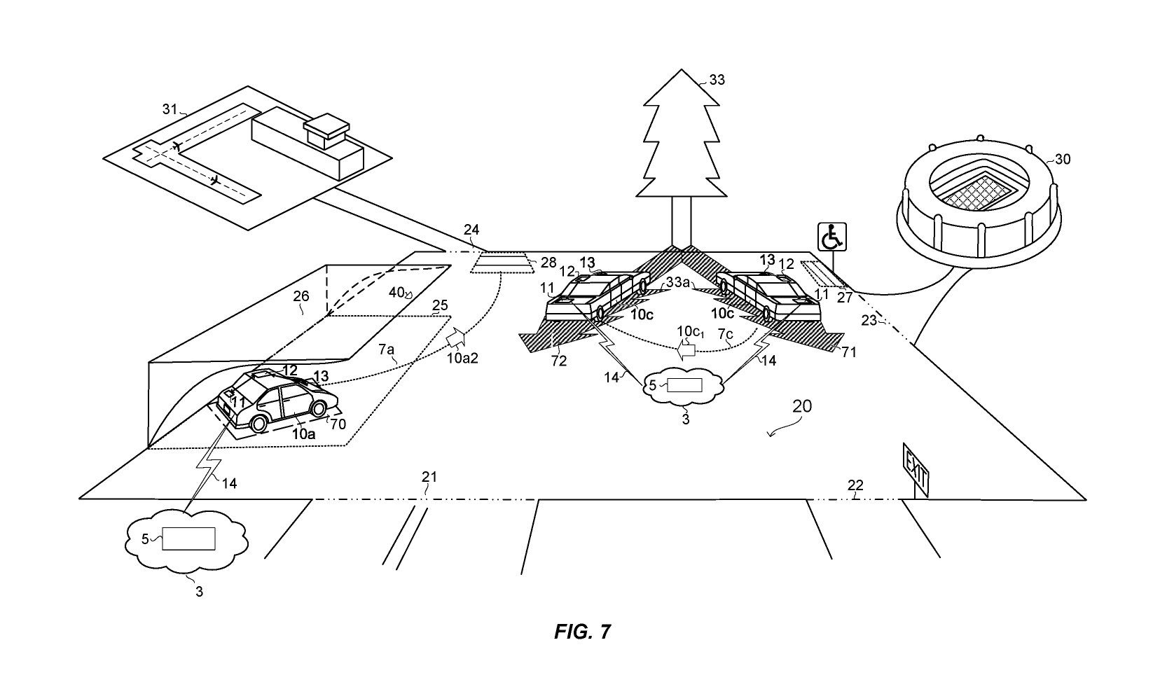

FIG. 6 in conjunction with FIG. 7 illustrates further exemplary operation flows of various aspects of the disclosure. Starting in block 610, vehicle 10a parked in a virtually partitioned portion 70 of parking area 20 is dynamically assigned to another virtually partitioned portion 28 of parking area 20 based on at least one predetermined criterion, such as an expected retrieval time of vehicle 10a from parking area 20. For example, if a driver for vehicle 10a is on a 5 day trip, such as based on driver's available flight information, then vehicle 10a, can be initially parked in the covered region(s) 25 under protective covering structure 26, and then, close to an expected retrieval time of vehicle 10a due to its driver's return flight, to be autonomously navigated to portion 28 to be in relative proximity of access point 24 for airport venue 31. In another example, a driver may provide an indication of his return to the parking area, such as after an event, via an internet device, such as a mobile phone or tablet, so to have vehicle 10a autonomously navigated in advance to a desired portion of the parking area 20, such as portion 28.

In another example, an autonomously navigated vehicle, such as vehicle 10c, is initially assigned to a portion 71 in proximity of tree 33 so to be under a shade 33a of tree 33. As the day progresses, such as from morning to late afternoon, shade 33a of tree 33 is moved due to the changing position of the overhead sun, from portion 71 to portion 72. Vehicle 10c is then dynamically reassigned to portion 72 to be once again placed under shade 33a of tree 33.

Next, in block 620, vehicles 10a and 10c, are guided to their respective new virtually partitioned portions, such as portions 28 and 72 in parking area 20, such as along routes 7a and 7c in direction of arrows 10a₂ and 10c₁, as shown in FIG. 7.

It is understood that specific order or hierarchy of steps in the processes is an illustration of exemplary approaches. Based upon design preferences, it is understood that the specific order or hierarchy of steps in the processes may be rearranged. Further, some steps may be combined or omitted. The accompanying method claims recite various steps in a sample order. Unless otherwise specified, the order in which the steps are recited is not meant to require a particular order in which the steps must be executed.

The previous description is provided to enable any person skilled in the art to practice the various aspects described herein. Various modifications to these aspects will be readily apparent to those skilled in the art, and the generic principles defined herein may be applied to other aspects.

Operations described in the present disclosure may be controlled and/or facilitated by software, hardware, or a combination of software and hardware. Operations described in the present disclosure may be controlled and/or facilitated by software executing on various machines, such as in the above-described remote server 5, vehicle(s) 10, or an on-site server (not shown), or any combination thereof. Such operations may also be controlled and/or facilitated specifically-configured hardware, such as field-programmable gate array (FPGA) specifically configured to execute the various steps of particular method(s). For example, relevant operations can be implemented in digital electronic circuitry, or in computer hardware, firmware, software, or in a combination thereof. In one example, a device may include a processor or processors. The processor may be coupled to a computer-readable medium, such as a random access memory (RAM). The processor may execute computer-executable program instructions stored in memory, such as executing one or more computer programs. Such processors may comprise a microprocessor, a digital signal processor (DSP), an application-specific integrated circuit (ASIC), field programmable gate arrays (FPGAs), and/or state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, optical media, magnetic tape or other magnetic media, and/or any other medium from which a computer processor can read. The processor, and the processing, described may be in one or more structures, and may be dispersed through one or more structures. The processor may comprise code for carrying out one or more of the methods (or parts of methods) described herein.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method, comprising:
receiving at least one request for parking a vehicle in a parking area;
virtually partitioning a portion of the parking area based on at least one of (a) dimensions of the vehicle or (b) attributes of the parking area, in the response to the request; and
dynamically assigning the virtually partitioned portion of the parking area to the vehicle, in response to the at least one request for parking the vehicle.

2. The method of claim 1, the virtually partitioning further comprising:
defining a virtual perimeter of the partitioned portion.

3. The method of claim 1, the virtually partitioning further comprising:
monitoring the parking area for available parking locations, and virtually partitioning a portion of an available parking location.

4. The method of claim 1, wherein the receiving the at least one request comprises receiving a plurality of requests for parking a plurality of vehicles in the parking area, and wherein the virtually partitioning comprises virtually partitioning a plurality of portions of the parking area, wherein each portion is virtually partitioned based on at least one of (a) dimensions of a corresponding vehicle in the plurality of vehicle or (b) attributes of the parking area.

5. The method of claim 1, wherein the attributes of the parking area comprise at least one of (a) a size of the parking area, (b) a shape of the parking area, (c) a proximity of different portions of the parking area to a venue, (d) a covered area within the parking area, (e) a nature of activity within the venue, or (f) a retrieval time of the vehicle from the parking area.

6. The method of claim 1, wherein the virtually partitioning the portion of the parking area is further based on an event.

7. The method of claim 1, further comprising:
guiding the vehicle to the assigned virtually partitioned portion of the parking area.

8. The method of claim 7, wherein guiding the vehicle comprises guiding the vehicle via a virtually defined route.

9. The method of claim 7, wherein guiding the vehicle comprises providing a virtually defined route to a driver of the vehicle.

10. The method of claim 7, wherein guiding the vehicle comprise monitoring a movement of the vehicle toward the assigned virtually partitioned portion.

11. The method of claim 7, further comprising:
dynamically reassigning a vehicle parked in a first virtually partitioned portion of the parking area to a second virtually partitioned portion of the parking area based on at least one predetermined criterion; and
guiding the vehicle to the second virtually partitioned portion of the parking area.

12. An apparatus, comprising:
at least one processor configured to receive at least one request for parking a vehicle in a parking area, to virtually partition a portion of the parking area based on at least one of (a) dimensions of the vehicle or (b) attributes of the parking area, in the response to the request, to dynamically assign the virtually partitioned portion of the parking area to the vehicle, in response to the at least one request for parking the vehicle; and
a data storage unit configured to communicate with the processor and to store information on the virtually partitioned portions.

13. The apparatus of claim 12, the at least one processor is further configured to define a virtual perimeter of the partitioned portion.

14. The apparatus of claim 12, the at least one processor is further configured to virtually define a route to the virtually partitioned portion, and to guide the vehicle to the assigned virtually partitioned portion via a virtually defined route.

15. The apparatus of claim 12, further comprising:
a monitor system configured to monitor a movement of the vehicle toward the assigned virtually partitioned portion.

16. The apparatus of claim 12, wherein at least one processor is configured to receive a plurality of requests for parking a plurality of vehicles in the parking area, and to virtually partition a plurality of portions of the parking area, wherein each portion is virtually partitioned based on at least one of (a) dimensions of a corresponding vehicle in the plurality of vehicle or (b) attributes of the parking area.

17. The apparatus of claim 12, wherein at least one processor is configured to dynamically reassign a vehicle parked in a first virtually partitioned portion of the parking area to a second virtually partitioned portion of the parking area based on at least one predetermined criterion; and to guide the vehicle to the second virtually partitioned portion of the parking area.

18. The apparatus of claim 14, further comprising a visualization module comprising a display unit, the visualization module configured to display a graphical superimposition on the parking area of the virtually defined route and the virtually partitioned portion.

19. An apparatus, comprising:
means for receiving at least one request for parking a vehicle in a parking area;
means for virtually partitioning a portion of the parking area based on at least one of (a) dimensions of the vehicle or (b) attributes of the parking area, in the response to the request; and
means for dynamically assigning the virtually partitioned portion of the parking area to the vehicle, in response to the at least one request for parking the vehicle.

20. The apparatus of claim 19, wherein the means for virtually partitioning further comprising:
means for defining a virtual perimeter of the partitioned portion.
